(19) United States
(12) Patent Application Publication
(10) Pub. No.: US 2006/0099041 A1
(43) Pub. Date: May 11, 2006

(54) Metal machining and drilling bits

(76) Inventor: David Rees Mugeli, Bowen (AU)

Correspondence Address: YOUNG & THOMPSON, 745 SOUTH 23RD STREET, 2ND FLOOR, ARLINGTON, VA, 22202, US

(21) Appl. No.: 10/536,995

(22) PCT Filed: Nov. 28, 2003
(86) PCT No.: PCT/AU03/01591

§ 371 Date: May 31, 2005

(30) Foreign Application Priority Data
Nov. 29, 2002 (AU) 2002952999

(51) Int. Cl. B23B 51/00

(52) U.S. Cl. 408/226

(57) ABSTRACT

The drill (20) include a shear off safety feature. The flats (21) are connected to the bit (22) via a wasted section (23) so that upon jamming of the bit in a workpiece the wasted section will twist and shear off releasing the operator. The shank of the bit is made long enough that even if it is sheared there is still enough shank so that the but may still be used to complete a drilling procedure if this be required. The shear torque is typically 15-30 ft lbs. Preferably 15-20 ft lbs for domestic drills and 20-30 ft lbs for industrial drills.

### TECHNICAL FIELD OF THE INVENTION

THIS invention concerns twist drills, router bits and like components which are normally held in three jaw chucks.

### BACKGROUND TO THE INVENTION

For both machining work and jobbing work the shanks of such bits are cylindrical and they rely on the operator tightening the chuck jaws to grip the shank firmly enough to impart the necessary torque. When unexpected hardness in the substrate is met, the bit may bind in the bore slowing the bit while the chuck may continue to spin. This interrupts the drilling operation and damages the bit.

Tradesmen commonly dispense with the chuck key when tightening a bit in the chuck, preferring to insert the required bit and then to grip the chuck briefly as it starts, using the torque of the drill to tighten the chuck. This helps to change bits quickly but chuck slip is common with such practice.

Spade bits have a single flat ground into the end 10 mm of the shank, but to improve grip this is intended to be placed adjacent a chuck jaw so that one jaw will close parallel to the flat.

Other drill bits are known that employ flats along the drill shank.

WO 02/064295 describes in combination a mounting portion of tool and a corresponding shank, the mounting portion of the holder has a ball-detent and the shank has a corresponding a circumferential groove where the circumferential groove is closely spaced from the insert end of the shank.

U.S. Pat. No. 5,466,100 describes a drill bit having a stepped construction, referred to as a cone drill, and a quick change capability provided by a shank having a non-circular cross-section and a circumferential groove for quick connect-disconnect in a power tool or drill. The cone drill has a circumferential groove close to the end of this is used as a reference point to enable an operator to select the particular hole diameter being drilled.

However, all these known bits are prone to jam and hence create a safety risk for an operator. It is an object of the present invention to reduce this safety risk.

### OUTLINE OF THE INVENTION

In one aspect therefore the invention provides a rotary bit with a shank adapted to locate in a chuck, the shank having an insert end and an end section extending from the insert end, the end section having at least one elongate flat which locates inside the chuck when the shank is operatively engaged in the chuck, and a wasted safety section spaced from the insert end by a spacing, the spacing of the wasted safety section from the insert end being sufficient so that when the shank is operatively engaged in the chuck, the wasted safety section is outside the chuck, the wasted safety section having a predetermined shear torque rating so that the shank shears at the wasted safety section if the predetermined shear torque rating is exceeded.

Preferably, the shear torque rating at which the wasted safety section shears is in the range 15-30 ft lbs.

Preferably, the shear torque rating at which the wasted safety section shears is in the range 15-20 ft lbs.

Preferably, the shear torque rating at which the wasted safety section shears is in the range 25-30 ft lbs.

Preferably, the shank includes a further flat outboard of the wasted safety section so that after the wasted safety section has been sheared, if necessary, a user may still use the bit on a temporary basis to complete a drilling task.

Preferably, the shank includes circumferentially spaced longitudinally extending flats which locate inside the chuck when the shank is operatively engaged in the chuck.

Preferably, the shank includes multiple longitudinally extending flats which locate inside the chuck when the shank is operatively engaged in the chuck.

Preferably, the shank has a regular polygonal section including multiple longitudinally extending flats which locate inside the chuck when the shank is operatively engaged in the chuck.

Preferably, the shank includes circumferentially spaced longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

Preferably, the shank includes multiple longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

Preferably, the shank has a regular polygonal section including multiple longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

Preferably, the rotary bit is a coded one of a coded set of safety bits, the code being according to the shear torque rating and risk factor associated with the type of drill being used.

Preferably, the rotary bit is a coded one of a coded set of safety bits, the code of each bit in the set being according to the shear torque rating and risk factor associated with the type of drilling activity being undertaken. The shank typically has three, six, nine or twelve flats arranged on the insert end of the shank in order to present a surface with is parallel to each jaw of the three jaw chuck.

The shear torque is typically 15-30 ft lbs. Preferably 15-20 ft lbs for domestic drills and 20-30 ft lbs for industrial drills.

When six, nine or twelve flats are present, the flats may be contiguous. When three flats are provided these may be mutually separated by arcuate portions of the shank in order to retain a substantial proportion of the section of the shank for taking the rotational force of the chuck. The flats and the arcuate separation of the flats may be of substantially equal sectors.

The flats may be machined, ground, or formed during manufacture.

Theoretically the best resistance to slippage occurs when there is a flat which mates with a closing jaw. Friction is independent of contact area and depends only upon the closing force and the coefficient of friction between the jaw and the shank. The shank is normally polished and therefore prone to slip, but the displacement of the jaw must occur before the shank can slip. Once flats have been provided on the shank physical displacement of the jaw is prevented. This ensures that chuck and shank rotate at the same speed rather than reliance upon friction.

Twelve seems to be the upper limit because a greater number begins to approximate to a circular section which is the cause of the slippage.

### BRIEF DESCRIPTION OF THE DRAWINGS

Certain embodiments of the invention are now described with reference to the accompanying drawings in which:

FIG. 1 is an end view of a partially open chuck;

FIG. 2 is a larger scale section of a shank with six flats;

FIG. 3 is a section of a shank with three flats;

FIG. 4 is a section showing a shear off safety feature applicable to the present invention; and

FIG. 5 is a graphical representation of torque in foot pounds against shear width in millimetres showing a range of widths suited to different applications.

### METHOD OF PERFORMANCE

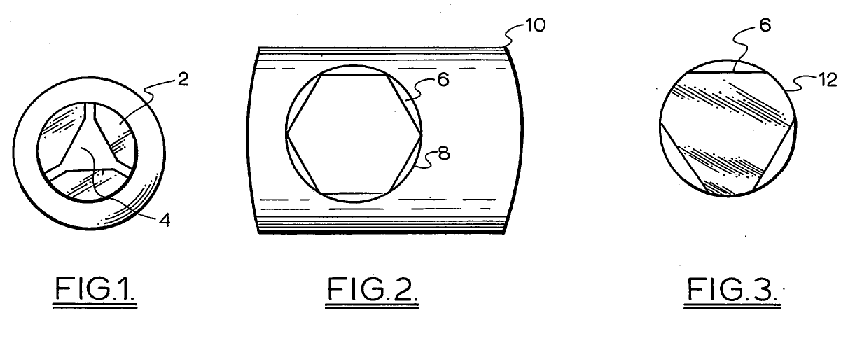

Referring to FIG. 1 the three jaws 2 define a triangular space 4 into which the shank of a twist drill is inserted. In FIG. 2 the flats 6 are ground in the insert end of an HSS shank 8 held in a tool head 10 which indexes. The flats produce a shank of hexagonal section.

In FIG. 3 the flats 6 are ground on three equi-spaced sectors of the shank diameter. The arc 12 between the flats are equal in distance to the width of the flats.

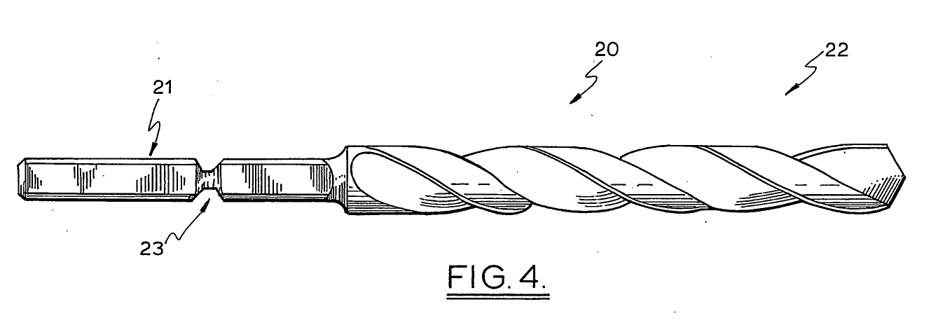

The drill includes a shear off safety feature. An example is shown in FIG. 4 at 20 where the flats 21 as previously described are connected to the bit 22 via a wasted section 23 so that upon jamming of the bit in a workpiece the wasted section will twist and shear off releasing the operator. It will be appreciated that the shank of the bit is made long enough that even if it is sheared there is still enough shank so that the drill may still be used to complete a drilling procedure if this be required. However this would not be the safest approach.

Applicant envisages torque safety settings dependent upon the level of skill or strength of an operator, the nature of the driving tool and the type of use. For example, household use might be divided into home use or handyman use, industrial use might be divided into light industrial and heavy industrial. The risks involved will vary and hence the torque safety level will vary as well.

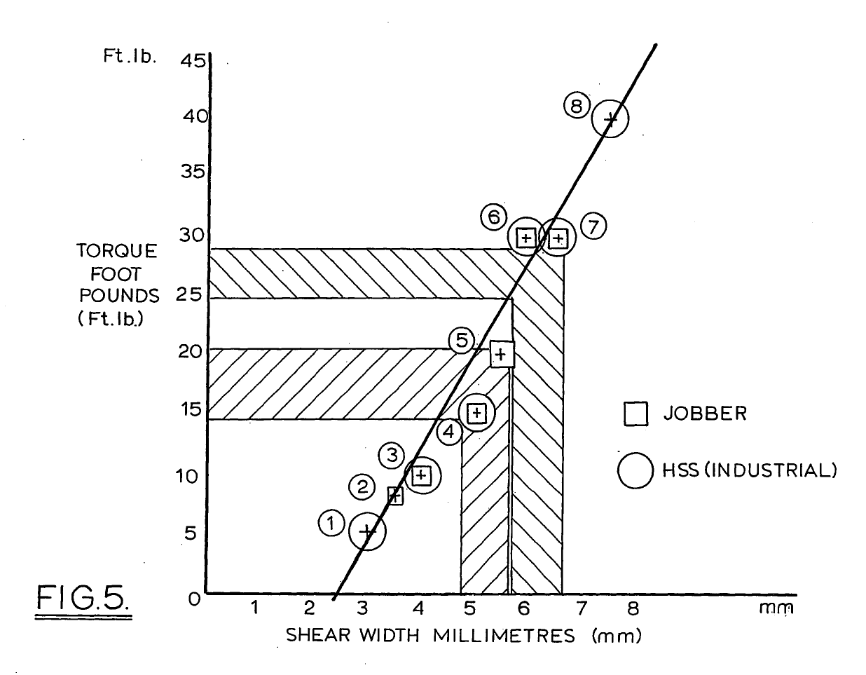

FIG. 5 shows the preferred torque settings for different applications, the shaded region from 15 ft lb torque to 20 ft lb torque is typical for a domestic hand drill whereas the 25 ft lb torque to 30 ft lb torque is preferred for larger industrial drills in industrial applications. The “jobber” bit is a lower quality steel than the HSS which refers to “high speed steel” rated bits. Consequently for most applications the wasted section will be between 5 mm and 7 mm. Having said this it is preferred that drill bits be colour coded in sets and a recommended coded drill bits for different applications so that the operator may know the safest drill bit for the particular application. For example, it may be desirable to select a lower shear width for situations where the operator is involved with overhead drilling as opposed to a more stable drilling position where the risk factor associated with a drill being jammed is less due to greater control of the drill is less awkward situations. Applicant recommends a safety rating of 20%-30% lower shear torque for overhead drilling than for horizontal applications. Thus for overhead applications in an industrial drill the code would be at the lower end of graph FIG. 5.

In terms of FIG. 5, the lowest torque setting could be 5 ft lbs for a hand held drill set that might be used occasionally by an inexperienced user. The upper level may be as high as 40 ft lbs in cases such as a drill press where risk of movement of the workpiece being drilled is the higher. On the other hand wrist injuries might be the higher risk for hand held pistol grip drills and a lower setting would apply. Thus, four sets of drill bits may be purchased, these may be coded by a coloured filler in the wasted section. Yellow might correspond to general household and have the lowest torque setting, green to home handyman, blue to light industrial and red to heavy industrial and so on as the torque setting increases.

Whilst the above has been given by way of illustrative example of the present invention many variations and modifications thereto will be apparent to those skilled in the art without departing from the broad ambit and scope of the invention as set out in the appended claims.

1. A rotary bit with a shank adapted to locate in a chuck, the shank having an insert end and an end section extending from the insert end, the end section having at least one elongate flat which locates inside the chuck when the shank is operatively engaged in the chuck, and a wasted safety section spaced from the insert end by a spacing, the spacing of the wasted safety section from the insert end being sufficient so that when the shank is operatively engaged in the chuck, the wasted safety section is outside the chuck, the wasted safety section having a predetermined shear torque rating so that the shank shears at the wasted safety section if the predetermined shear torque rating is exceeded, wherein the shank includes a further flat outboard of the wasted safety section so that after the wasted safety section has been sheared, if necessary, a user may still use the bit on a temporary basis to complete a drilling task.

2. A rotary bit according to claim 1 wherein the shear torque rating at which the wasted safety section shears is in the range 15-30 ft Ibs.

3. A rotary bit according to claim 1 wherein the shear torque rating at which the wasted safety section shears is in the range 15-20 ft bs.

4. A rotary bit according to claim 1 wherein the shear torque rating at which the wasted safety section shears is in the range 25-30 ft Ibs.

5. (canceled)

6. A rotary bit according to claim 1 wherein the shank includes circumferentially spaced longitudinally extending flats which locate inside the chuck when the shank is operatively engaged in the chuck.

7. A rotary bit according to claim 1 wherein the shank includes multiple longitudinally extending flats which locate inside the chuck when the shank is operatively engaged in the chuck.

8. A rotary bit according to claim 1 wherein the shank has a regular polygonal section including multiple longitudinally extending flats which locate inside the chuck when the shank is operatively engaged in the chuck.

9. A rotary bit according to claim 1 wherein the shank includes circumferentially spaced longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

10. A rotary bit according to claim 1 wherein the shank includes multiple longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

11. A rotary bit according to claim 1 wherein the shank has a regular polygonal section including multiple longitudinally extending flats which locate inside the chuck when the shank is operatively engaged in the chuck and there being matching flats outboard of the wasted safety section so that after the wasted safety section has been sheared, if necessary, a user may still use the bit on a temporary basis to complete a drilling task.

12. A rotary bit according to claim 1 wherein the rotary bit is a coded one of a coded set of safety bits, the code being according to the shear torque rating and risk factor associated with the type of drill being used.

13. A rotary bit according to claim 1 wherein the rotary bit is a coded one of a coded set of safety bits, the code of each bit in the set being according to the shear torque rating and risk factor associated with the type of drilling activity being undertaken.

14. A rotary bit according to claim 1 wherein the shank includes circumferentially spaced longitudinally extending flats which locate inside the chuck when the shank is operatively engaged in the chuck and the shear torque rating at which the wasted safety section shears is in the range 15-30 ft bs.

15. A rotary bit according to claim 1 wherein the shank includes multiple longitudinally extending flats which locate inside the chuck when the shank is operatively engaged in the chuck and the shear torque rating at which the wasted safety section shears is in the range 15-30 ft Ibs.

16. A rotary bit according to claim 1 wherein the shank has a regular polygonal section including multiple longitudinally extending flats which locate inside the chuck when the shank is operatively engaged in the chuck and the shear torque rating at which the wasted safety section shears is in the range 15-30 ft Ibs.

17. A rotary bit according to claim 1 wherein the rotary bit is a coded one of a coded set of safety bits, the code being according to the shear torque rating and risk factor associated with the type of drill being used and the shear torque rating at which the wasted safety section shears is in the range 15-30 ft bs.

18. A rotary bit according to claim 1 wherein the rotary bit is a coded one of a coded set of safety bits, the code of each bit in the set being according to the shear torque rating and risk factor associated with the type of drilling activity being undertaken and the shear torque rating at which the wasted safety section shears is in the range 15-30 ft bs.

19. A rotary bit according to claim 1 wherein the shank includes circumferentially spaced longitudinally extending flats which locate inside the chuck when the shank is operatively engaged in the chuck and the shear torque rating at which the wasted safety section shears is in the range 25-30 ft Ibs.

20. A rotary bit according to claim 1 wherein the shank includes multiple longitudinally extending flats which locate inside the chuck when the shank is operatively engaged in the chuck and the shear torque rating at which the wasted safety section shears is in the range 25-30 ft Ibs.

21. A rotary bit according to claim 1 wherein the shank has a regular polygonal section including multiple longitudinally extending flats which locate inside the chuck when the shank is operatively engaged in the chuck and the shear torque rating at which the wasted safety section shears is in the range 15-30 ft Ibs.

22. A rotary bit according to claim 1 wherein the rotary bit is a coded one of a coded set of safety bits, the code being according to the shear torque rating and risk factor associated with the type of drill being used and the shear torque rating at which the wasted safety section shears is in the range 25-30 ft Ibs.

23. A rotary bit according to claim 1 wherein the rotary bit is a coded one of a coded set of safety bits, the code of each bit in the set being according to the shear torque rating and risk factor associated with the type of drilling activity being undertaken and the shear torque rating at which the wasted safety section shears is in the range 25-30 ft Ibs.

24. A rotary bit according to claim 1 wherein the shank includes circumferentially spaced longitudinally extending flats which locate inside the chuck when the shank is operatively engaged in the chuck and the shear torque rating at which the wasted safety section shears is in the range 15-20 ft (bs.

25. A rotary bit according to claim 1 wherein the shank includes multiple longitudinally extending flats which locate inside the chuck when the shank is operatively engaged in the chuck and the shear torque rating at which the wasted safety section shears is in the range 15-20 ft Ibs.

26. A rotary bit according to claim 1 wherein the shank has a regular polygonal section including multiple longitudinally extending flats which locate inside the chuck when the shank is operatively engaged in the chuck and the shear torque rating at which the wasted safety section shears is in the range 15-20 ft bs.

27. A rotary bit according to claim 1 wherein the rotary bit is a coded one of a coded set of safety bits, the code being according to the shear torque rating and risk factor associated with the type of drill being used and the shear torque rating at which the wasted safety section shears is in the range 15-20 ft Ibs.

28. A rotary bit according to claim 1 wherein the rotary bit is a coded one of a coded set of safety bits, the code of each bit in the set being according to the shear torque rating and risk factor associated with the type of drilling activity being undertaken and the shear torque rating at which the wasted safety section shears is in the range 15-20 ft Ibs.

29. A rotary bit according to claim 1 wherein the shear torque rating at which the wasted safety section shears is in the range 5-40 ft bs.

30. A rotary bit according to claim 1 wherein the shank includes multiple longitudinally extending flats which locate inside the chuck when the shank is operatively engaged in the chuck and the shear torque rating at which the wasted safety section shears is in the range 5-40 ft bs.

31. A rotary bit according to claim 1 wherein the shank has a regular polygonal section including multiple longitudinally extending flats which locate inside the chuck when the shank is operatively engaged in the chuck and the shear torque rating at which the wasted safety section shears is in the range 5-40 ft Ibs.

32. A rotary bit according to claim 1 wherein the rotary bit is a coded one of a coded set of safety bits, the code being according to the shear torque rating and risk factor associated with the type of drill being used and the shear torque rating at which the wasted safety section shears is in the range 5-40 ft bs.

33. A rotary bit according to claim 1 wherein the shank has a regular polygonal section including multiple longitudinally extending flats which locate inside the chuck when the shank is operatively engaged in the chuck and the shear torque rating at which the wasted safety section shears is in the range 5-40 ft bs.
